(19) United States
(12) Patent Application Publication
(10) Pub. No.: US 2004/0100911 A1
(43) Pub. Date: May 27, 2004

(54) Method for link adaptation

(76) Inventors: Raymond Kwan, Vancouver (CA); Klaus Ingemann Pedersen, Aalbory (DK); Preben Mogensen, Gistrup (DK); Trpels Kolding, Klarup (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/302,955

(22) Filed: Nov. 25, 2002

(51) Int. Cl. H04J 1/16; H04J 3/16

(52) U.S. Cl. 370/252; 370/465

(57) ABSTRACT

According to the invention a method is provided for a link adaptation for a transmission of data from a sender to a receiver through a communication channel to a variation of a transmission condition of said communication channel. The method comprises the steps of ascertaining at least one current value of at least a first quantity indicative of said transmission condition, comparing said current value with a first target value of said first quantity, modifying the ratio between said first target value and said current value of said first quantity in dependence on the result of said comparing step, and selecting a modulation and coding scheme for said data transmission from a predetermined number of modulation and coding schemes in dependence on the result of said comparing step and on the result of said modifying step. According to the method of the invention, in addition to an inner loop adaptation of the MCS a further adaptation of the first target value is performed. That is, there is a second, outer loop control mechanism for an ongoing transmission. This way, a better link adaptation may be obtained.

### FIELD OF THE INVENTION

The invention relates to a link adaptation method for a transmission of data from a sender to a receiver through a communication channel to a variation of a transmission condition of said communication channel. It also relates to a network node adapted to performing link adaptation.

### BACKGROUND OF THE INVENTION

Adapting transmission parameters of a communication channel to changing channel conditions can bring benefits. A good channel condition requires a lower power level to maintain a predetermined signal quality level.

The process of changing transmission parameters of a communication channel to compensate for the variation in the channel condition is generally referred to as link adaptation (LA).

In a well known LA method, a fast power control algorithm, the transmission power between a mobile station (user equipment, UE) and a base station in a wireless system is adjusted based on channel fading. This is described in Janne Laakso, Harri Holma, and Oscar Salonaho “Radio Resource Management”, to be found in: Holma Harri, Toskala Antti (ed.), “WCDMA for UMTS Radio Access for Third Generation Mobile Communications”, John Wiley & Sons, 2000, revised edition, pp.183 to 214. As a result, higher power efficiency as well as better interference control can be achieved.

Beside the above described power control method, adaptive modulation and coding (AMC) is known as another form of link adaptation method. It comprises selecting a modulation and coding scheme (MCS) as well as a number of multicodes for transmission. The goal of AMC is to change the modulation and coding scheme according to the varying channel conditions. A user with favorable channel conditions can be assigned higher order modulation with higher code rates. The opposite is true when the user has unfavorable channel conditions.

The AMC LA algorithm aims at selecting the optimum MCS and number of multicodes depending on the experienced signal-to-Interference ratio (SIR) at the UE, given some total transmit power and code constraints. The obtainable SIR at the UE may be implicitly obtained via a channel quality indicator (CQI) report from the UE and/or via monitoring of the transmit power of the associated dedicated channel (DCH) to the UE. The transmit power of the associated DCH is effected by the received power control commands from the UE. We will refer to LA based on these measures as inner loop LA.

Using multicodes is a technique to provide high-rate data transmission. In mobile networks, there are two important techniques to provide high rate data transmission. The first one is the so-called single code scheme, in which the bit rate depends on a spreading factor (SF). A lower spreading factor (SF) channelization code is used to provide a higher bit rate. However, with the constraint of the total bandwidth as well as the chip rate used, the increase in the data bitrate is proportional to the decrease of the processing gain. In the multicode scheme a high rate data stream is divided into a number of lower rate data sub-streams. All of these sub-streams are transmitted in parallel synchronous multicode channels, so that there is no time delay between each other. As a result, beside an increased data rate, interference observed by one channel due to the other channels is avoided.

A first benefit of AMC is that higher bit rates can be achieved when a user is in a good channel condition. As a result, the averaged throughput can be enhanced. A second benefit of AMC is that interference is reduced by changing the modulation and coding schemes (MCS) instead of the transmitted power. AMC is proposed to be used for the downlink shared channel in the High Speed Downlink Packet Access (HSDPA) in the 3GPP standardization.

However, due to various imperfections in the system, estimation errors etc., the AMC LA algorithm may suffer from a bias in the estimation of the SIR at the UE.

Due to the nature of the adaptive modulation and coding as a form of fast link adaptation, and also due to the nature of the link level error performance, the frame error rate (FER) of the packets using the AMC scheme can be much smaller than the error threshold used to determine the MCS and multicodes, if a constant power is used. Usually, however, non-realtime traffic, such as packet traffic, can tolerate a much longer delay, and, thus, more retransmissions. As a result, a very low frame error rate is not a necessary requirement for packet traffic. If the actual frame error rate is low compared to the error threshold, transmission power is wasted and may cause interference to the own and other cells. Moreover, the power used is not available for other services in the same cell.

### SUMMARY OF THE INVENTION

It is therefore an object of the invention to provide a link adaptation method that is able adapt a transmission parameter to a varying channel condition irrespective of a bias in the estimation of the SIR at the UE.

It is a further object of the invention to provide a link adaptation method that is capable of allocating a power level to a transmission that is adequate with respect to a required frame error rate.

It is a further object of the invention to provide a link adaptation method that reduces interference within a cell and between neighboring cells in wireless communication.

It is a further object of the invention to provide a link adaptation method that results in a number of retransmissions that is adequate with respect to a required frame error rate.

These objects are solved by a method according to claim 1, a network node according to claim 25 and a network according to claim 32.

According to the present invention a method is provided for a link adaptation for a transmission of data from a sender to a receiver through a communication channel to a variation of a transmission condition of said communication channel. The method comprises the steps of

ascertaining at least one current value of at least a first quantity indicative of said transmission condition,

comparing said current value with a first target value of said first quantity,

modifying the ratio between said first target value and said current value of said first quantity in dependence on the result of said comparing step, and

selecting a modulation and coding scheme for said data transmission from a predetermined number of modulation and coding schemes in dependence on the result of said comparing step and on the result of said modifying step.

According to the method of the invention, in addition to an adaptation of the MCS a further adaptation of the first target value is performed. That is, there is a second control mechanism for an ongoing transmission. This way, a better link adaptation may be obtained.

The invention provides a second link adaptation method in addition to the MCS adaptation. This link adaptation is provided by the step of modifying the ratio between said first target value and said current value of said first quantity in dependence on the result of said comparing step. By modifying this ratio, the step of selecting a modulation and coding scheme is influenced. This does not imply that the selecting step necessarily leads to a different result than in a case where the ratio is not changed. However, in many situations there will indeed be a different result. By adapting the target value to the transmission condition of the communication channel, the step of selecting a MCS can be performed in better adaptation to the actual channel conditions.

The method of the invention provides two essential benefits: (I) The algorithm is able to remove any bias introduced by the inner loop LA algorithm, and (II) it provides an efficient instrument for controlling the number of retransmissions. Controlling the number of retransmissions implies controlling the hardware utilization, as each transmission requires hardware resources.

The link adaptation method of the invention is an outer loop adaptation method. That means, it adapts a transmission quality target to the actual transmission condition measured. Known outer loop link adaptation methods concern the transmission power level. In contrast, the method of the invention provides an outer loop link adaptation method concerning an adaptation of the MCS, such as in AMC. This way, the method of the invention is able to provide a “fine tuning” that adds to the adaptation of an inner loop AMC LA method.

The step of ascertaining at least one current value of at least a first quantity indicative of said transmission condition may comprise measuring the current value or receiving the current value from a measurement unit at a different network node. There may be more than one quantity ascertained. The first quantity may be one or more of the group of the SIR, the FER, the BLER, a CQI, and a response signal from the receiver of the current transmission acknowledging error free reception of an individual PDU or a reception error.

According to the invention, the step of selecting an MCS involves obtaining information on whether the current channel condition is in accordance with a preset requirement. A current, i.e., present value of a quantity indicative of the current transmission condition is ascertained by measuring and evaluating. As mentioned above, the present value of the first quantity may also be read from an external source. The first quantity may be for instance the signal-interference-ratio, a frame error rate, a CQI, etc. Then the current value of the first quantity is compared with a target value. The selection of the MCS is based on given information on the performance of a particular MCS at the given channel condition.

The step of modifying the ratio between said first target value and said current value of said first quantity in dependence on the result of said comparing step may be performed in different ways according to different embodiments of the invention.

In a first preferred embodiment said modifying step comprises a step of setting said first target value. That means the ratio is changed by changing the first target value.

In a second preferred embodiment, said modifying step comprises a step of multiplying said current value of said first quantity by a scaling factor. That is, in this embodiment the ratio is changed by scaling the present value of the first quantity while leaving the target value unchanged.

It may also be considered to change both, the target value and the present value of the first quantity. However, this is more complicated, since additional care must be taken in such an embodiment that the ratio is changed by the adaptation.

In a third preferred embodiment, that may be combined with the first or the second preferred embodiment, the selecting step further comprises a step of setting a number of multicodes for said data transmission in dependence on the result of said comparing step, on the selected modulation and coding scheme and on the result of said modifying step. In this embodiment of the invention, the complete adaptive modulation and coding link adaptation which per se is known from the art, is made to work under an outer loop link adaptation algorithm. The AMC selection is dependent on the modifying step.

In a further embodiment, the ascertaining step comprises a step of determining a ratio of energy per bit to a spectral noise density at said input of said receiver from said signal amplitude. This example of the first quantity is widely used in the art in known power control algorithms. Therefore, this embodiment fits well into he environment of known control algorithms.

A further embodiment of the invention comprises a step of setting a transmission power level in dependence on the result of said comparing step. A variation of the transmission power level allows to directly influence the SIR. The power level is, beside the MCS and number of multicodes, another transmission parameter that is able to react to varying channel conditions. An adjustment of the power level in addition performing the AMC link adaptation provides another degree of freedom in the link adaptation scheme of the method of the invention.

In this embodiment, the modifying step preferably comprises a step of changing the transmission power level by a preset amount. The amount preset in one embodiment depends on whether said current value is smaller or larger than said first target value. This way, the speed of adaptation of the power level is made different for transmission conditions that presently are “too good” or “too bad”, respectively.

In the first preferred embodiment, setting said first target value is preferably performed in dependence on the result of said comparing step and on a second target value of a second quantity. By providing a second quantity that influences the setting of the first target value, the link adaptation method can be performed in the framework of a preset quality requirement. This quality requirement may be set according to a predetermined service class or to the requirements of the ongoing data transmission (e.g., speech call, data transfer). The second quantity may for instance be a frame error rate or a block error rate. A target SIR may for instance be set in dependence on the preset frame error rate. In this embodiment the first target value depends on a second target value of a second quantity. For a given MCS and multicode combination the SIR threshold value depends on the required frame error rate, as will be shown below with reference to FIG. 1. In this embodiment, the method the decision made in the inner loop AMC mechanism is influenced not only by setting the first target value, but indirectly also by the second target value, which may also be set.

In a further preferred embodiment of the method of the invention, setting said transmission parameter is performed in dependence on said response from the receiver to a previous transmission.

In this form of the first embodiment, the step of setting the first target value preferably comprises a step of changing a current value of said first target value by an amount that is dependent on the difference between a current value of said second quantity and said second target value of said second quantity. This may involve measuring the current value of the second quantity or ascertaining it from other sources like another network node involved in the data transmission.

The second preferred embodiment of the invention that was mentioned above and that involves multiplying the current value of said first quantity by a scaling factor for a modification of the mentioned ratio, preferably comprises a step of ascertaining the scaling factor. This way, the scaling factor can be individually adapted to a given transmission condition. However, care must be taken to provide a damping mechanism in the adaptation method of the invention according to this embodiment. Therefore, the step of ascertaining the scaling factor preferably depends on a response from the receiver to a previous data transmission, said response indicating whether the previous data was received free of errors by said receiver. This may, for instance be a known “Ack” or “Nack” message. In this embodiment, a step of ascertaining how often said data transmission has been transmitted by the sender is preferably performed before adapting the scaling factor. This way, an unnecessary adaptation due to a short-time channel disturbance can be avoided. In case there has been a number of retransmissions the scaling factor is increased.

In this algorithm, the scaling factor is adjusted and provided as input to the inner loop LA algorithm. The inner loop algorithm uses the scaling factor to scale the estimate of the SIR. Fixed increment or decrement parameters can be adjusted by the radio network planner. In general, the ratio between the increment and the decrement parameter determines the residual block error rate (BLER) after the second transmission. The outer loop algorithm of this embodiment therefore provides an efficient instrument for the radio network planner to control the number of retransmissions for HSDPA.

The method of the invention is preferably used for controlling the transmission of data through a downlink data communication channel between a mobile network node and a fixed network node.

According to another aspect of the invention, a network node is provided. The network node of the invention comprises

a measurement unit, adapted to ascertain at least one current value of at least a first quantity indicative of a transmission condition of a communication channel for an ongoing data transmission between said network node and a second network node, and to provide at least one first signal indicative of said current value,

a first target memory comprising at least one first target value of said first quantity,

a comparing unit, communicating with said measurement unit and said target memory, and adapted to perform at least one step of comparing said first signal with said first target value and to provide a second signal indicative of the result of said comparison step,

a transmission control unit communicating with said comparing unit and adapted to set at least one transmission parameter in dependence on said second signal, wherein said transmission control unit is further adapted to set said first target value in dependence on a second target value of a second quantity that is dependent on a success rate for said data transmission.

The network node of the invention is adapted to perform the method of the invention described above. The transmission control unit is preferably adapted to ascertain or select a modulation and coding scheme used for said data transmission and to set said first target value in dependence of the ascertained or selected modulation and coding scheme, respectively. Ascertaining the MCS may involve receiving a selection command from another network node. However, the transmission control unit is in a preferred embodiment adapted to perform a selecting algorithm. An example of such an algorithm will be explained below with reference to FIG. 2.

The transmission control unit of the network node of the invention is in a first embodiment adapted to perform the link adaptation method according to its first preferred embodiment described above. In this embodiment, the network node is preferably a mobile UE. It may, however, also be implemented into the fixed Network node, such as in a Node B or a Radio Network Controller (RNC).

A network node adapted to perform the second preferred embodiment of the method of the invention is preferably a Node B.

### BRIEF DESCRIPTION OF THE DRAWINGS

In the following, the present invention will be described in greater detail based on two preferred embodiments with reference to the figures, in which:

FIG. 1 shows in an upper diagram a schematic representation of the dependency of the frame error rate on channel condition ρ for different combinations ƒ_{i,j} of Modulation and Coding Schemes (MCS) and number of multicodes, and in a lower diagram a schematic representation of the distribution function g as a function of the channel condition ρ;

FIG. 2 shows a flow diagram of an example of a method for determining the Modulation and Coding Scheme (MCS) and the number of multicodes for a transmission;

FIG. 3 shows in a diagram the dependency of the average observed frame error rate as a function of the channel condition ρ for three different frame error thresholds;

FIG. 4 shows in a diagram the dependency of the threshold of the frame error rate used in the method of FIG. 2 for three different channel conditions ρ;

FIG. 5 shows a flow diagram of a first preferred embodiment of outer loop link adaptation for adaptive modulation and coding with multicodes;

FIG. 6 shows in a flow diagram as a first preferred embodiment of an outer loop link adaptation method an algorithm that can be used to obtain a target value ρ_{target} for each MCS/multicode combination;

FIG. 7 shows in a flow diagram of a second preferred embodiment of an outer loop link adaptation method for Adaptive Modulation and Coding and adaptive selection of the number of multicodes;

FIG. 8 shows an example of a distribution of successful transmissions for different settings of the scaling factor in the embodiment of FIG. 7;

FIG. 9 shows in a diagram the average throughput loss as a function of the number of transmissions in the embodiment of FIG. 7;

FIG. 10 shows a block diagram of a network node implementing the method of the invention.

### DESCRIPTION OF THE PREFERRED EMBODIMENT

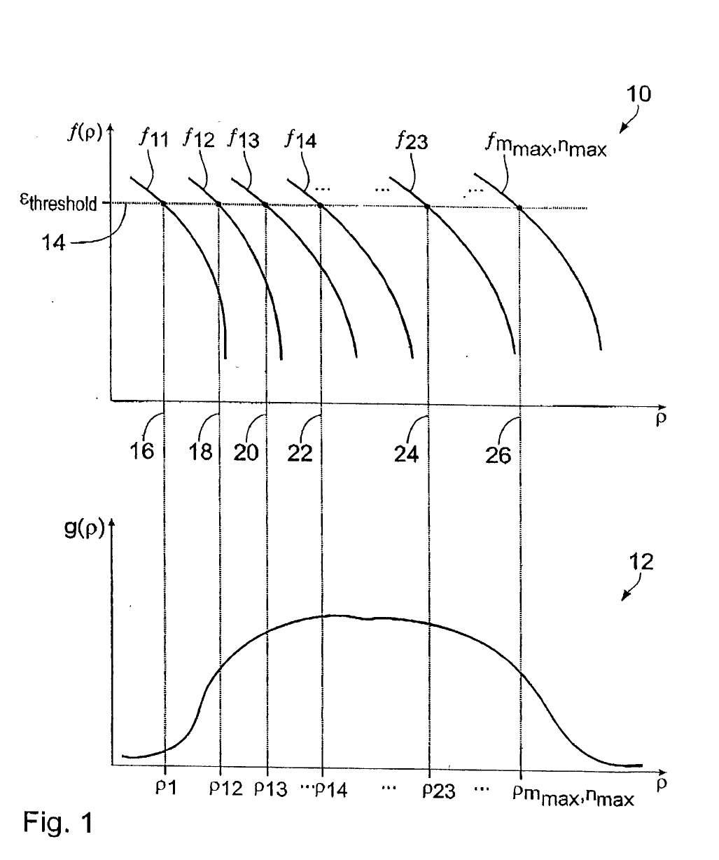

FIG. 1 shows in an upper diagram 10 a schematic representation of the dependency of the error performance ƒ_{i,j} on channel condition ρ for different combinations of Modulation and Coding Schemes (MCS) and number of multicodes. The index i corresponds to the MCS, and the index j corresponds to the number of multicodes. The criteria for such error performance can be, for example, the Frame Error Rate (FER) or the Block Error Rate (BLER). In a lower diagram 12 a schematic representation of the probability density function g (ρ) of the channel condition ρ is shown.

In the upper diagram 10 of FIG. 1 the the error performance ƒ is plotted as a function of the Signal-to-Interference ratio (SIR) ρ=E_{b}/N₀ for different combinations of MCS and number of multicodes, represented by reference signs f₁₁, f₁₂, f₁₃, f₁₄, f₂₃, and f_{mmax,nmax}. The curves shown do not correspond to actual calculations or measurements. They are a schematic representation of the general behavior of the error performance in dependence on the SIR and on the combination of a Modulation and Coding scheme with a given number of multicode channels. E_{b} is the Energy per Blt, N₀ is the Spectral Noise Density, SIR and ρ have the same meaning throughout this description. The criteria for such error performance can be, for example, the Frame Error Rate (FER) or the Block Error Rate (BLER). In the remaining part of this document, unless specified, FER can be used as the error performance measure.

Each of the curves f₁₁, f₁₂, f₁₃, f₁₄, f₂₃, and f_{mmax,nmax} shown represents the frame error rate for a given Modulation and Coding scheme and a given number of multicode channels in dependence of ρ. The indexing of the reference signs indicates in its first digit a particular MCS chosen and in its second digit the number of multicodes. For example, f₁₁ represents the frame error curve for the first MCS with single code transmission.

Also shown in FIG. 1 is a horizontal dotted line 14 that represents a predetermined upper threshold value ε_{threshold} of the frame error rate. Vertical dotted lines 18 to 26 represent the SIR at which the upper threshold frame error rate value ε_{threshold} is met by a particular combination of MCS and number of multicode channels.

Each of the curves shows a characteristic behavior well known in the art. The frame error rate decreases with increasing SIR. Roughly speaking, the better the signal, the lower the frame error rate. To meet the upper threshold value of the frame error rate, different modulation and coding schemes need different SIRs. Similarly, the higher the number of multicodes used, the higher the SIR necessary for a given ε_{threshold}. This accounts for the horizontal shift seen between the different curves of the MCS and multicode combinations shown.

It is clearly seen from the upper diagram of FIG. 1 that each combination of MCS and a number of multicode channels has an individual threshold SIR that is needed to meet the FER threshold requirement. These threshold SIR values are designated ρ₁₁, ρ₁₂, ρ₁₃, ρ₁₄, ρ₂₃, and ρ_{mmax,nmax}, respectively, at the abscissa of the lower diagram of FIG. 1 for the corresponding frame error rate curves of the upper diagram.

Also shown in FIG. 1 is, in the lower diagram 12, the probability density function g (ρ) of the channel condition ρ when a single code channel is used. For example, at a given MCS, if 2 code channels are used instead of a single code channel, higher power is needed to provide the same frame error rate. From g (ρ), it is possible to determine the joint probability distribution of the selected MCS and the number of multicodes. It can be seen from the upper diagram 10 of FIG. 1 that there is in general more than one MCS/multicode combination with a value ƒ(ρ) below ε_{threshold} for a given value of ρ. This shows that with a predetermined FER threshold and a given SIR ρ there is room for changing the MCS/multicode combination in order to optimize the bit transmission rate.

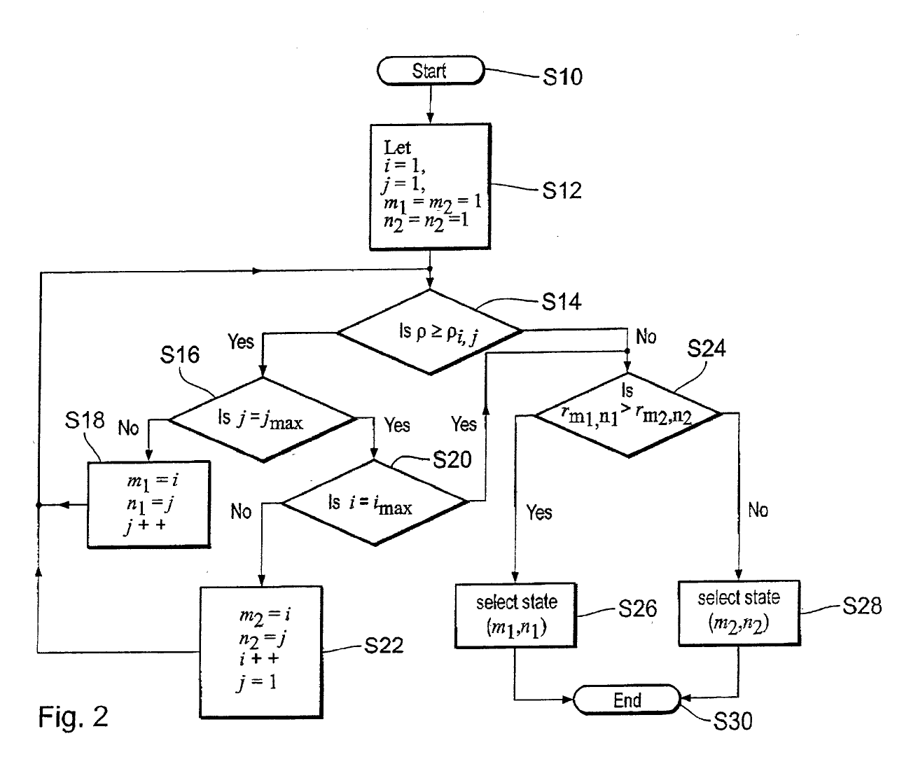

FIG. 2 shows a flow diagram of a method for determining the Modulation and Coding Scheme (MCS) and the number of multicodes for a transmission given a measured SIR ρ. The algorithm serves to optimally select the MCS and the number of multicodes given a channel condition E_{b}/N₀. Instead of power control, adaptive modulation and coding with multicodes is used as a form of link adaptation. Thus, with a constant power, the channel condition gives rise to a certain E_{b}/N₀. The selection of the MCS and the number of multicodes depend upon a given E_{b}/N₀ and a given, fixed error threshold.

In the method of FIG. 2 it is assumed that a number iₘₐₓ of Modulation and Coding schemes (MCS) and a number jₘₐₓ of multicodes are available for link adaptation with Adaptive Modulation and Coding (AMC). A situation in which a MCS indexed I and a number j of multicodes is used for transmission is called a state (i,j) in the following.

The method is started with a step S10. In a step S12 the index i to a scheme for modulation and coding, and the number of multicode channels used for the transmission are preset to the value 1. Similarly, temporary state indexes m₁, m₂, n₁, and n₂ are given the value 1.

In a step S14 the channel condition is measured, and the SIR ρ determined this way is compared to the corresponding SIR threshold value ρᵢⱼ. If the measured value ρ is larger than the threshold value for the given MCS/multicode combination it means that there is an excess amount of power used for the transmission in comparison to the bit transmission rate data rate obtained, given the target frame error threshold value ε_{threshold}. Under these circumstances, there is room for an optimization of the transmission parameters in order to obtain a higher bit transmission rate.

Therefore, the method proceeds in the left branch of the flow diagram of FIG. 2 with step S16 in which it is ascertained whether the number j of multicodes is at its, maximum value. If this is not the case, the indexes of the cureent state are saved into a first temporary state m₁=i, n₁=j, and the index j for the number of multicodes is incremented in a step S18. After this, the method switches back to step S14 in order to check for the new temporary state with an increased number of multicodes, whether the SIR is still higher than the threshold value for this temporary state.

On the other hand, in step S16, if the number of multicodes has reached its maximum, in a step S20 the Index I for the MCS is tested for having reached its maximum value, if this is not the case, the indexes of the cureent state are saved into a second temporary state m₂=i, n₂=j, and the index i for the MCS is incremented in a step S22. In addition the index j for the number of multicodes is reset to 1. After this, the method switches back to step S14 in order to check for the new temporary state with a different modulation and coding scheme, whether the SIR is still higher than the threshold value for this temporary state. From there on, the method again runs the optimization branch for the number j of multicodes as long as the measured SIR is higher than the respective SIR threshold.

If either in step S14 it is found that the measured SIR is smaller than the threshold value of the current state i, j, or in step S20 it is found that the state with the highest number jₘₐₓ of multicodes and with the highest index for a modulation and coding scheme has been reached by the process, the method proceeds in a step S24 with comparing the bit transmission rates of the first and second temporary states. The state with the higher bit transmission rate is chosen in either step S26 or S28. The method ends with a step S30.

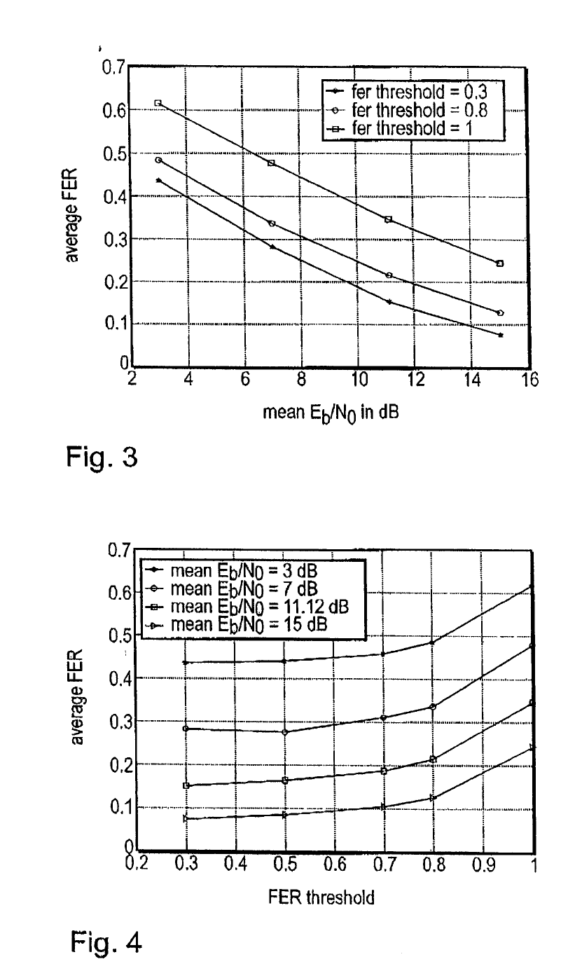

FIG. 3 shows in a diagram the dependency of the average observed frame error rate as a function of the channel condition ρ for three different frame error thresholds;

With the AMC and multicode algorithm of FIG. 2, it is possible to evaluate the bit rate performance either numerically or by Monte Carlo simulation. As an example, we assume that 4 MCS are used, and a maximum number of allowed multicodes for each MCS is 3. The allowed MCS are QPSK ½, QPSK ¾, 16 QAM ½, 16 QAM ¾.

For this case, FIG. 3 shows the average observed frame error rate (FER) as a function of channel conditions Eb/No at different frame error thresholds. It is worth noticing that the actual observed average FER is much lower than the FER, threshold ε_{threshold} used in the algorithm. This phenomenon is especially visible when the channel condition is good (i.e. high mean Eb/No). At a particular ε_{threshold}, the successive ρ_{i,j}'s are relatively far apart as shown in FIG. 1. Due to the very steep nature of the FER as a function of ρ, the average FER over the successive intervals of ρ_{i,j} is small. As a result, very small FER is observed even if the FER threshold ε_{threshold} can be large.

FIG. 4 shows the dependency between the average FER and the FER threshold with the mean values of 4 different distributions of the channel condition ρ. As shown in FIG. 3, the average observed FER and the channel condition Eb/No is almost linearly related over the range shown.

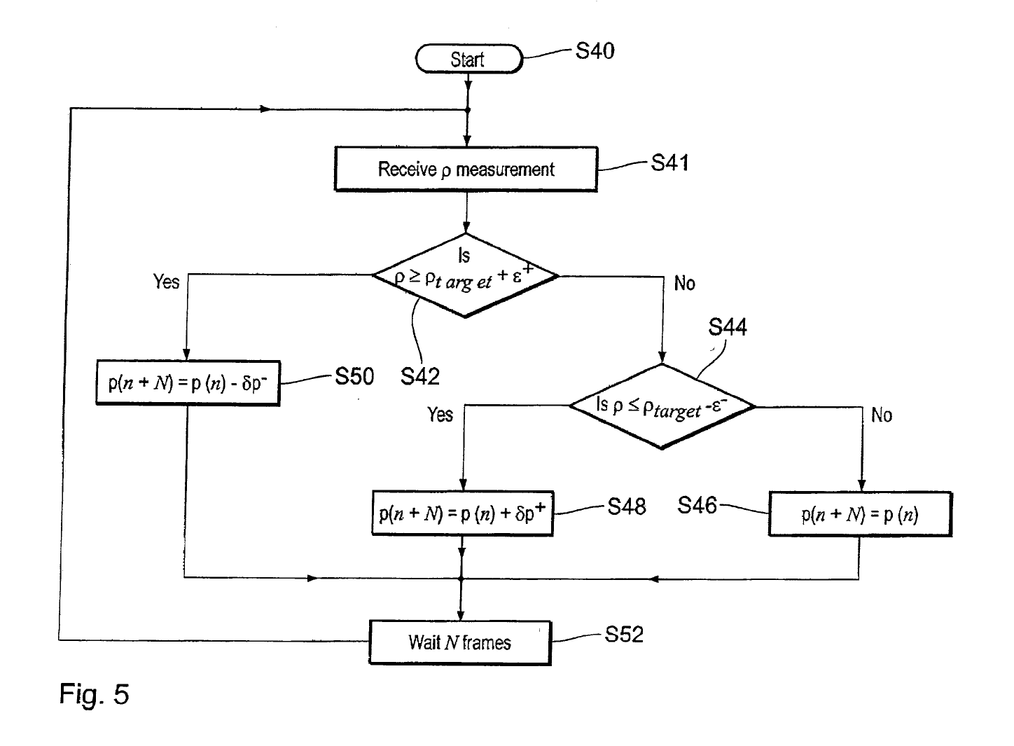

In FIG. 5 a flow diagram of an inner loop link adaptation method for adaptive modulation and coding with multicodes is shown. The idea behind this embodiment is to modify the power level p allocated to a particular channel, for instance the Downlink Shared Channel DCH. The downlink shared channel is a downlink transport channel shared by several UEs.

It is the aim to adjust ρ=E_{b}/N₀ to a E_{b}/N₀ target value which corresponds to the desired frame error rate. The adjustment made by this method is slow compared to the inner loop link adaptation AMC of FIG. 2. However, the inner loop LA method described in FIG. 2 can only react to a given E_{b}/N₀. With respect to FIG. 1 this implies that the inner loop link adaptation of FIG. 2 can shift the transmission state only in a direction parallel to the ordinate axis, i.e. change the frame error rate by choosing a different MCS/multicode combination for a given SIR. The present link adaptation method allows to shift the transmission state in a direction parallel to the abscissa, i.e., change the SIR of the transmission channel.

The method starts with a step S40. In a step S41 a ρ=E_{b}/N₀ measurement report is received. In following steps S42 and S44 this current SIR value, i.e., the current ρ=E_{b}/N₀, is compared with a small interval around the a target value ρ_{target}, ρ_{target} is the desired channel condition Eb/No value which corresponds to the desired frame error rate (FER). Step S42 checks whether ρ is larger than or equal to ρ_{target}+ε⁺ wherein ε⁺ is a predetermined margin parameter that defines the target upper threshold for ρ. If ρ does not exceed ρ_{target}+ε⁺ the method continues in step S44 with checking whether ρ is smaller than or equal to the target lower threshold, ρ_{target}−ε⁻. If this is also not the case, the power p allocated to the transmission channel will be set to the current value for the next N frames in step S46. If, however ρ is smaller than ρ_{target}−ε⁻ the power p allocated to the transmission channel for the next N frames is increased by a first power step δp⁺ in step S 48.

In case it is ascertained in step S42 that ρ is larger than or equal to ρ_{target}+ε⁺ the power p allocated to the transmission channel for the next N frames is decreased by a second power step δp⁻ in step S48. From S46, S48 and S50 the method proceeds with waiting the next N frames to receive the next ρ=E_{b}/N₀ measurement report in step S41.

In this algorithm, the variables ρ_{target}, δp⁻, δp⁺, ε⁺, and ε⁻ are system parameters.

There is an absolute maximum power Pₘₐₓ that can be allocated to the channel using the algorithm. This parameter can be very slowly adjusted based on the load condition.

The value ρ_{target} is not a constant value. The channel condition which gives rise to a particular FER value depends very much upon which modulation and coding scheme and the number of multicodes are chosen, cf. FIG. 1. In fact, the ρ_{target} can be chosen to be the average of all ρ_{target} values corresponding to the MCS/multicode combinations over the the duration of the call.

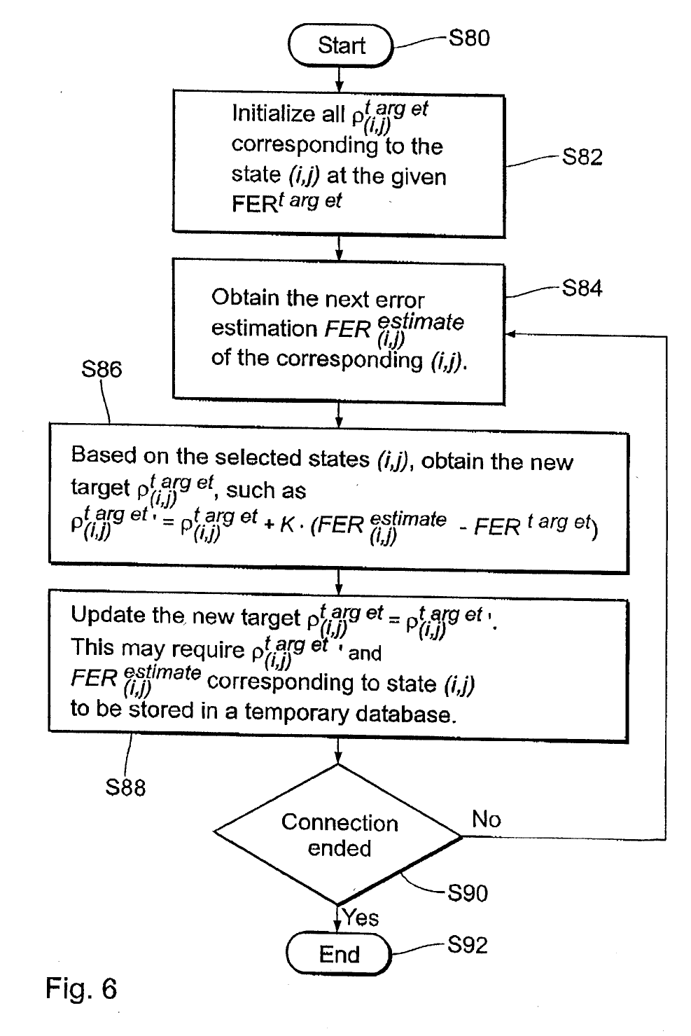

FIG. 6 shows an example of an outer loop link adaptation algorithm that can be used to obtain the ρ_{target} for each MCS/multicode combination. The algorithm is started in a step S80. Let

$${ρ}_{( i , j )}^{target}$$

be the Eb/No target corresponding to the state (i,j), and

$${FER}_{( i , j )}^{estimate}$$

be the estimated frame error rate corresponding to the state (i,j) when

$${ρ}_{( i , j )}^{target}$$

is used. FER^{target} is the target frame error rate, which can be the previously defined ε_{threshold}. At the beginning, in a step S82 all

$${ρ}_{( i , j )}^{target}$$

are set according to FER^{target} as in FIG. 1. Each time a state (i,j) is selected, the

$${FER}_{( i , j )}^{estimate}$$

is obtained in a step S84. As a result, the

$${ρ}_{( i , j )}^{target}$$

corresponding to the state (i,j) is obtained and updated in a step S86 as

$${ρ}_{( i , j )}^{{target}_{1}} = {ρ}_{( i , j )}^{target} + K \cdot ( {FER}_{( i , j )}^{estimate} - {FER}^{target} ) , \qquad ( 1 )$$

where K is a predefined parameter,

$${ρ}_{( i , j )}^{target}$$

is updated by

$${ρ}_{( i , j )}^{{target}_{1}}$$

in a step S88.

In the algorithm depicted in FIG. 6,

$${ρ}_{( i , j )}^{target}$$

is only updated when the state (i,j) is invoked. In other words,

$$\{ {ρ}_{( m , n )}^{target} , ( m , n ) \neq ( i , j ) \}$$

are not updated. As a result, if a new state (m,n) is selected for the next transmission, the old

$${ρ}_{( m , n )}^{target}$$

would be used.

One possible solution to this problem is to approximate

$$\{ {ρ}_{( m , n )}^{target} , ( m , n ) \neq ( i , j ) \}$$

when the state (i,j) is chosen for the current transmission via linear approximation. Recall in FIG. 1 that ƒ_{i,j}(ρ) is the error performance ε as a function of the channel condition ρ for the state (i,j), which can be expressed as

$${f}_{i , j} ( ρ ) = {\sum }_{n = 0}^{∞} \frac{1}{n !} {f}_{i , j}^{( n )} ( {ρ}^{*} ) {( ρ - {ρ}^{*} )}^{n} \qquad ( 2 )$$

where ρ⁺ is a biasing parameter,

$${f}_{i , j}^{( n )} ( \cdot )$$

is the n^{th} derivative of ƒ_{i,j}(ρ). Taking up to the linear term of equation (2), ƒ_{i,j}(ρ) can be approximated as

ƒ_{i,j}(ρ)=ƒ_{i,j}(ρ)+ƒ_{i,j}(ρ)(ρ−ρ) (3)

where ƒ′_{i,j}(.) is the first derivative of ƒ_{i,j}(ρ). Thus, equation (1) can now be rewritten as

$${ρ}_{i , j}^{{target}_{1}} = {ρ}_{i , j}^{target} + \frac{{FER}_{( i , j )}^{estimate} - {FER}^{target}}{{f}_{i , j}^{′} ( {ρ}^{*} )} \qquad ( 4 )$$

Using the error estimate

$${FER}_{( i , j )}^{estimate}$$

of state (i,j), the Eb/No target

$$\{ {ρ}_{( m , n )}^{target} , ( m , n ) \neq ( i , j ) \}$$

can be approximated as

$${ρ}_{m , n}^{{target}_{1}} = {ρ}_{m , n}^{target} + \frac{{FER}_{( i , j )}^{estimate} - {FER}^{target}}{{f}_{m , n}^{′} ( {ρ}^{*} )} . \qquad ( 5 )$$

In equation (4) and (5), ρis a biasing parameter. With this algorithm, the Eb/No target for all other states (m,n) can be adjusted even if only the error estimate

$${FER}_{( i , j )}^{estimate}$$

is given at the current transmission. With this procedure, a better Eb/No target can be used when the next chosen state is different from the current one.

While adapting the ρ to the ρ_{target} is a rough way of adjusting the FER, an independent or additional fine adjustment can be done using the frame error rate threshold ε_{threshold} as defined in the AMC/multicode algorithm, cf. FIG. 1. FIG. 4 shows that the actual FER can be adjusted by fine-tuning the error threshold ε_{threshold}. Although this adjustment of ε_{threshold} does not provide as much the dynamic range as ρ, it does provide another degree of freedom for fine adjustment.

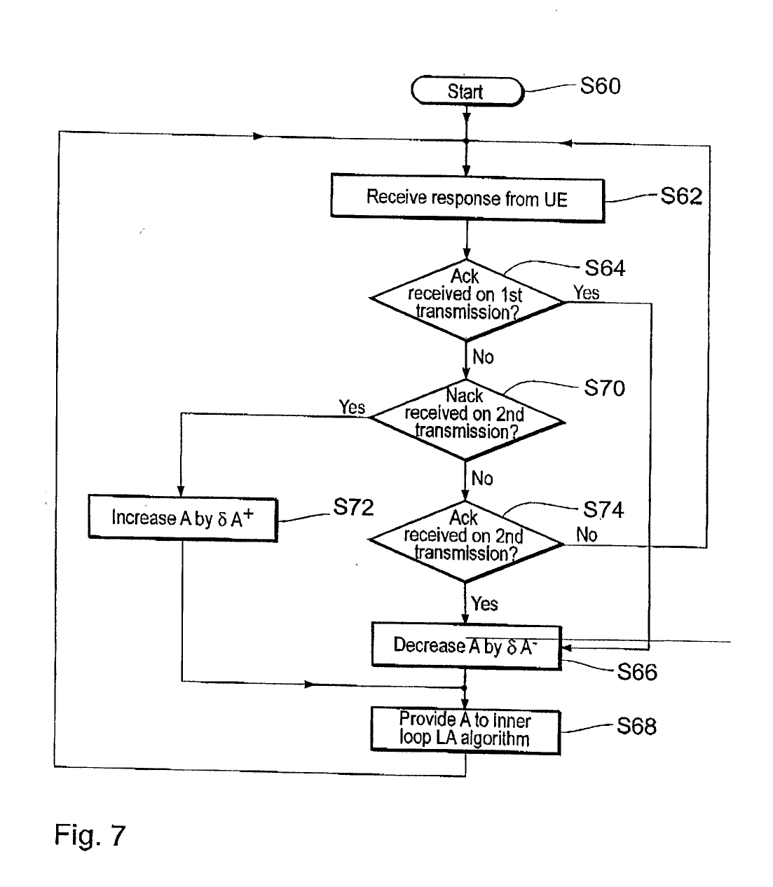

FIG. 7 shows in a flow diagram a second preferred embodiment of an outer loop link adaptation method. In this algorithm, a scaling factor A is adjusted and provided as an input to an inner loop LA algorithm. The inner loop algorithm uses A to scale the estimate of the SIR.

This method can be used with an inner loop link adaptation method that applies adaptive coding and modulation and adaptive selection of the number of multicodes. The outer loop LA algorithm of this embodiment relies on ACK/NACK responses received from the UE. In a downlink session between a UE and a transmission device such as a base station, the UE receives packet data units (PDUs) from the transmission device and sends back an ACK (Acknowledged) or NACK (Not Acknowledged) response, depending on whether the PDU was properly received.

This method is especially suited for use with a Hybrid Automatic Repeat Request (HARQ) method for a High Speed Downlink Packet Access (HSDPA) as provided in 3G communication networks. An Automatic Repeat Request (ARQ) method comprises sending a number of repeats of each coded data packet. The repeats are sent upon an request of the receiver (such as a NACK response), that has detected an error in a PDU. A Hybrid ARQ method comprises the joint use of ARQ and a Forward Error Coding (FEC) method. An FEC method provides correction of the most-likely errors.

The method of the present embodiment starts with a step S60. In a step S62 a response is received on a transmission of a PDU from the UE. In a step S64 the response is evaluated. It is checked whether an ACK response was received for a PDU after a first transmission of this data packet. If it was, the method branches to a step S66, in which the scaling factor A is reduced by a preset first scaling step δA⁻. The reduced scaling factor A−δA⁻ is provided to the inner loop LA algorithm in a step S68.

If the result of the evaluation of step S64 is “NO”, the evaluation of the response continues in a step S70. Here it is checked whether a NACK message was received for a PDU after a second transmission of this data packet. If it was, the method branches off to a step S72, in which the scaling factor A is increased by a preset second scaling step δA⁺. The increased scaling factor A+δA⁺ is provided to the inner loop LA algorithm in step S68.

If the result of the evaluation of step S70 is “NO”, the evaluation of the response continues in a step S74. It is checked whether an ACK response was received for a PDU after the second transmission of this data packet. If it was, the method branches off to step S66, in which the scaling factor A is reduced by a preset first scaling step δA⁻. The reduced scaling factor A−δA⁻ is provided to the inner loop LA algorithm in step S68.

If the answer to the evaluation of step S74 is “NO” it means that the response from the receiver was to a third, fourth, or further transmission. Such retransmissions do not lead to an adaptation of the scaling factor A according to the present method.

Therefore, the method switches back to step S62 to wait for the next response from the receiver.

The outer loop algorithm of FIG. 7 only relies on Ack's from first and second transmission, and Nack's on second transmissions. Nack's on first transmissions and Ack/Nack's on X-transmissions for X>2 are ignored by the present outer loop adaptation method. The method is therefore primarily controlled by Ack/Nack's on second transmissions, where the Block Error Rate (BLER) typically is low, and therefore a more reliable input parameter.

The fixed parameters δA⁺ and δA⁻ can be adjusted by the radio network planner. Notice that in general the ratio between δA⁺ and δA⁻ determines the residual BLER after the second transmission. The proposed outer loop algorithm does therefore provide an efficient instrument for the radio network planner to control the number of retransmissions for HSDPA. Typical parameter settings are δA⁺=0.5 dB and δA⁻=0.1 dB for an approximate equivalent BLER on second transmission of −15%.

The outer loop LA algorithm of FIG. 7 for HSDPA provides two essential benefits: The algorithm removes any bias introduced by the inner loop LA algorithm and provides an efficient instrument for controlling the number of retransmissions. It is worth noticing that controlling the number of retransmissions is the same as controlling the hardware utilization, as each transmission requires hardware resources.

It is noted that the outer loop link adaptation algorithm of FIG. 7 can be used with the inner loop link adaptation method of FIG. 2. However, it may also be used with other known AMC inner loop LA methods.

The scaling factor A provides a modified SIR-value to the inner loop LA method that is used as a basis for selecting the MCS and number of multicodes, even though the value actually measured may be different from the modified SIR-value. With reference to FIG. 1, this corresponds to a shift in a direction parallel to the abscissa, just like increasing the SIR-value by increasing the transmission power according to the outer loop method of FIG. 5.

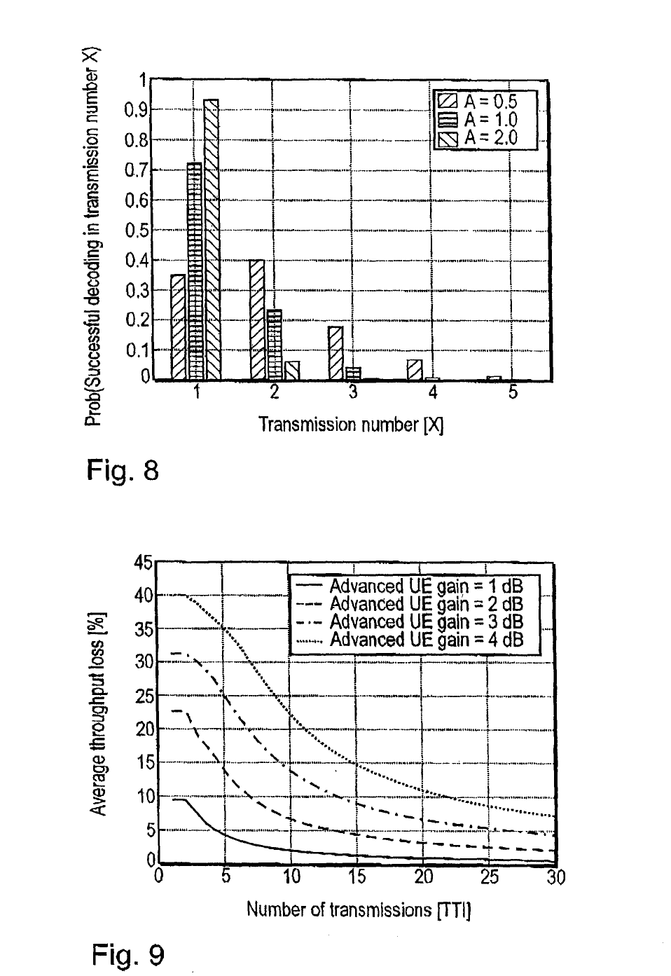

FIG. 8 shows in a diagram the probability of successful decoding a PDU in a transmission, hereinafter decoding probability, as a function of the transmission number. The diagram is based on a simulation calculation. The underlying assumption for this plot is that the inner loop algorithm aims at a BLER target of 30% for the first transmission for A=1. Further, it is assumed that a fading ITU Pedestrian A channel is used for transmission, that the UE is moved at a speed of 3 km/h, G=0.0 dB, and that the outer loop link adaptation is switched off.

On the abscissa transmission numbers from 1 to 5 are plotted. Probabilities are shown as columns. The simulation was performed for three different preset scaling factors for each transmission number. The decoding probability for a scaling factor A=0.5 is shown by columns hatched diagonally from the lower left to the upper right, for a scaling factor A=1.0 by columns hatched horizontally, and for a scaling factor A=2.0 by columns hatched diagonally from the upper left to the lower right.

The diagram shows that for a scaling factor A=2 the decoding probability is highest for the first transmission and decreases with each step. The same is true for a scaling factor of A=1, even though the probabilities at the respective transmission steps are lower than for A=2. For A=0.5 however, the decoding probability is highest at the second transmission step. This shows, that the the distribution of the number of transmissions can be controlled by adjusting the scaling factor A.

FIG. 9 presents the converge behavior of the outer loop algorithm. It shows the average throughput loss due to the finite convergence rate of the outerloop algorithm as a function of the number of transmissions. Four curves are shown for the case where the bias in the inner loop is a constant of 1, 2, 3, and 4 dB, respectively. The figure clearly indicates that with a bias of 4 dB a loss of 40% in throughput is experienced. However, with the proposed outer loop algorithm the loss is gradually reduced as the algorithm starts to converge and compensate for the bias in the inner loop algorithm.

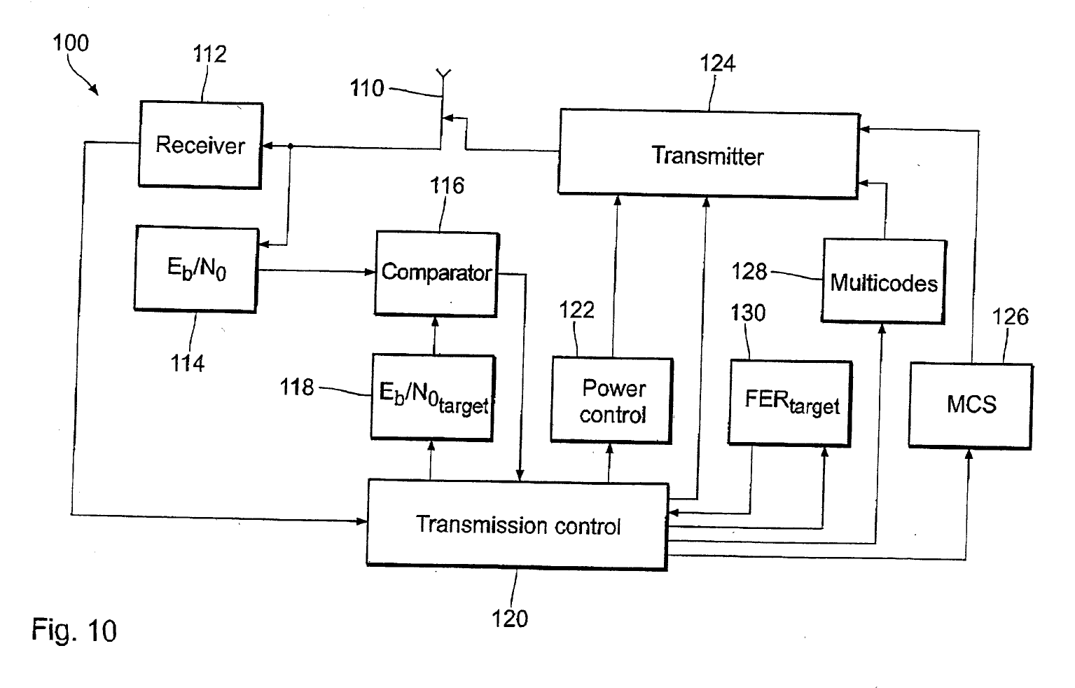

FIG. 10 shows a block diagram of a network node 100 implementing the method of the invention. The block diagram is simplified to concentrate on functional elements necessary for the present invention.

The network node 100 may be a user equipment (UE), for instance a mobile telephone (cellular phone) or a PDA (personal digital assistant) device.

The UE has an antenna 110. The antenna 110 is connected in parallel to a receiver unit 112 and a measurement unit 114. The receiver unit 110 is not described in detail. It is well known from prior art. In the measurement unit, the current value of the E₆/N₀ ratio is determined. This involves a measurement of a signal power, a determination of the Energy per Bit (Eb), a measurement of a power of the signal background to determine the Spectral Noise Density (No), and, finally, the determination of the ratio of the measured values. Instead of the determination procedure just described, another quantity may be determined from the measurement that is dependent on the E_{b}/N₀ ratio. E_{b}/N₀ is a measure of signal to noise ratio for a digital communication system. The measurement unit may also be integrated into the receiver unit 110.

The measurement unit 114 is connected to a comparator unit 116. Beside a first input connected to the measurement unit 114, comparator unit 116 has a second input that is connected to a first memory 118 containing a target value for the E_{b}/N₀ ratio. Preferably, first memory 118 contains a number of target values, each assigned to a particular combination of MCS and number of multicodes used in the current transmission. Comparator unit 116 receives at its second input the E_{b}/N₀ target value assigned to the MCS and number of multicodes used in the current transmission. Comparator unit 116 compares the value of the E_{b}/N₀ ratio received at its first input with the target value received at its second input. It performs the steps S42 and S44 described with reference to FIG. 5. The result of the comparison is communicated through an output of the comparator unit 116 to a transmission control unit 120.

Transmission control unit performs one of the steps S46 to S50, depending on the information received from comparator unit 116. It sets a power level of a current transmission. The power level set is communicated through transmitter 124 via a control channel to the network node transmitting the received data to the UE.

Transmission control unit 120 performs the outer loop link adaptation, i.e., the setting of the E_{b}/N₀ target value according to the algorithm of FIG. 6. For this, it is connected to a fourth memory containing a Frame Error Rate (FER) target value. FER estimates are ascertained from the current E_{b}/N₀ value and the modulation and coding scheme and number of multicodes currently used. As an alternative the current FER estimate is determined by the receiver 112 and communicated to the transmission control unit 120.

In order to allow the outer loop link adaptation method of FIG. 6 to have an influence on the MCS and multicode number, transmission control unit 120 also performs the inner loop link adaptation method of FIG. 5. Thus, the algorithm of FIG. 5 uses the E_{b}/N₀ target value set by the outer loop algorithm by FIG. 6 and sets a power level, that will serve as a basis for the link adaptation according to FIG. 2.

Transmission control unit 120 is also adapted to perform the selection of the modulation and coding scheme and of the number of multicodes to be used for the current transmission according to the algorithm presented in FIG. 2. For this, it is connected to a second memory 126 containing modulation and coding schemes, and to a third memory 128 containing multicodes. The transmission power level may influence the current value of ρ that is used in step S14. The algorithm of FIG. 2 adapting the MCS and the number of multicodes will therefore react to the transmission power level selected, if necessary.

The structure shown in FIG. 10 may, with some modifications in the functionality of the transmission control unit, also be implemented in a node B to provide it with an enhanced link adaptation tool. In a node B, transmission control unit 120 is adapted to perform the outer loop link adaptation method according to FIG. 7. In one embodiment of the node B, this is outer loop link adaptation is provided instead of the outer loop link adaptation of FIG. 6. In another embodiment, a switching possibility is provided in the node B (not shown) to change the link adaptation method between that of FIG. 6 and that of FIG. 7.

In the node B, the receiver will perform steps S62, S64, S70 and S74 and communicate the result of the respective ascertaining steps to the transmission control unit 120. Transmission control unit 120 performs steps S66, S72, and S68. Any known inner loop link adaptation method may be implemented in the node B. An example is that shown in FIG. 10, where the inner loop mechanism is the power control method of FIG. 5. By the outer loop mechanism of FIG. 7, the E_{b}/N₀ target value in the first memory 118 is scaled by the factor A. This scaling will influence the output signal of comparator 116 that in turn is used for the determination of the power level to be chosen by transmission control unit 120. Another form of inner loop link adaptation is the method of FIG. 2. This may be used as an alternative to the method of FIG. 5 in the node B.

The invention is preferably used in a third generation mobile network. However, it is not restricted to a use with such a network.

1. A link adaptation method for a transmission of data from a sender to a receiver through a communication channel to a variation of a transmission condition of said communication channel, comprising the steps of
ascertaining at least one current value of at least a first quantity indicative of said transmission condition,
comparing said current value with a first target value of said first quantity,
modifying the ratio between said first target value and said current value of said first quantity in dependence on the result of said comparing step, and
selecting a modulation and coding scheme for said data transmission from a predetermined number of modulation and coding schemes in dependence on the result of said comparing step and on the result of said modifying step.

2. A method according to claim 1, wherein said modifying step comprises a step of setting said first target value.

3. A method according to claim 1, wherein said selecting step further comprises a step of setting a number of multicodes for said data transmission in dependence on the result of said comparing step, on the selected modulation and coding scheme and on the result of said modifying step.

4. A method according to claim 1, wherein said ascertaining step comprises a step of measuring a signal amplitude at an input of said receiver.

5. A method according to claim 4, wherein said ascertaining step comprises a step of determining a ratio of energy per bit to a spectral noise density at said input of said receiver from said signal amplitude.

6. A method according to claim 1, comprising a step of setting a transmission power level in dependence on the result of said comparing step.

7. A method according to claim 6, wherein said modifying step comprises a step of changing said transmission power level by a preset amount.

8. A method according to claim 7, wherein said preset amount depends on whether said current value is smaller or larger than said first target value.

9. A method according to claim 2, wherein setting said first target value is performed in dependence on the result of said comparing step and on a second target value of a second quantity.

10. A method according to claim 9, wherein said second quantity is indicative of a transmission failure rate for said data transmission or is, in particular, a frame error rate or a block error rate.

11. A method according to claim 9, wherein said setting step comprises a step of changing a current value of said first target value by an amount that is dependent on the difference between a current value of said second quantity and said second target value of said second quantity.

12. A method according to claim 9, comprising a step of setting said second target value.

13. A method according to claim 2, wherein said comparing step comprises a step of ascertaining whether said current value of said first quantity falls within an interval of values containing said first target value.

14. A method according to claim 1, wherein said modifying step comprises a step of multiplying said current value of said first quantity by a scaling factor.

15. A method according to claim 14, comprising a step of ascertaining said scaling factor.

16. A method according to claim 14, comprising, before said modifying step, a step of receiving a response from said receiver to a previous data transmission, said response indicating whether the data was received free of errors by said receiver.

17. A method according to claim 16, wherein said response is an “Acknowledge” or a “Not acknowledge” message, respectively.

18. A method according to claim 16, wherein said step of ascertaining said scaling factor comprises a step of evaluating said response.

19. A method according to claim 16, comprising a step of ascertaining how often said data transmission has been transmitted by the sender.

20. A method according to claim 19, wherein said scaling factor is decreased given that the response indicates that said data transmission was received free of errors at a first or second transmission attempt.

21. A method according to claim 19, wherein said scaling factor is increased given that the response indicates that said data transmission was not received free of errors at a second transmission attempt.

22. A method according to claim 1, wherein said ratio between said first target value and said current value of said first quantity is modified for a preset time span or a preset number of transmissions, or, in particular, a preset number of frames.

23. A method according to claim 1, wherein said ascertaining, comparing, selecting, and modifying steps are performed repeatedly during said data transmission.

24. A method according claim 1, wherein said method is performed for controlling the transmission of data through a downlink data communication channel between a first, mobile network node and a second network node.

25. Network node, comprising
a measurement unit, adapted to ascertain at least one current value of at least a first quantity indicative of a transmission condition of a communication channel for an ongoing data transmission between said network node and a second network node, and to provide at least one first signal indicative of said current value,
a first target memory comprising at least one first target value of said first quantity,
a comparing unit, communicating with said measurement unit and said target memory, and adapted to perform at least one step of comparing said first signal with said first target value and to provide a second signal indicative of the result of said comparison step,
a transmission control unit communicating with said comparing unit and adapted to set at least one transmission parameter in dependence on said second signal, wherein said transmission control unit is further adapted to set said first target value in dependence on a second target value of a second quantity that is dependent on a success rate for said data transmission.

26. Network node according to claim 25, wherein said transmission control unit is adapted to ascertain or select a modulation and coding scheme used for said data transmission and to set said first target value in dependence of the ascertained or selected modulation and coding scheme, respectively.

27. Network node according to claim 26, wherein said transmission control unit is adapted to ascertain or select a number of multicodes used for said data transmission and to set said first target value in dependence of the ascertained or selected number of multicodes, respectively.

28. Network node according to claim 25, wherein said second quantity is a Frame Error Rate (FER) or a Block Error Rate (BLER).

29. Mobile network node according to claim 25.

30. Network node according to claim 25, wherein said second quantity comprises information about the success of a transmission of an individual data packet.

31. Node B according to claim 29.

32. Network, comprising a network node according to claim 25.
